(19) United States
(12) Patent Application Publication
(10) Pub. No.: US 2018/0341886 A1
(43) Pub. Date: Nov. 29, 2018

(54) METHOD OF ITERATIVE SCHEDULING AND SYSTEM OF THE SAME

(71) Applicant: Aktana, Inc., San Francisco, CA (US)

(72) Inventors: Robert Flint, San Francisco, CA (US); Jin Huang, San Francisco, CA (US); Derek Choy, San Francisco, CA (US); David Ehrlich, San Francisco, CA (US)

(21) Appl. No.: 16/051,395

(22) Filed: Jul. 31, 2018

Related U.S. Application Data
(63) Continuation-in-part of application No. 13/889,283, filed on May 7, 2013.
Application No. 13/889,283 is a continuation of application No. 13/767,815, filed on Feb. 14, 2013, now Pat. No. 8,744,890.
(60) Provisional application No. 61/800,939, filed on Mar. 15, 2013.

(51) Int. Cl. G06Q 10/06

(52) U.S. Cl. CPC G06Q 10/0633

(57) ABSTRACT

A decision support engine for dynamically scheduling interactions between a first party and a second party includes: a processor and a memory coupled to the processor. The memory having stored therein instructions, that, when executed by the processor, cause the processor to: receive an inputted target file including a target number of first channel interactions and a target number of second channel interactions; receive an inputted date period; receive calendar data of the first party; distribute the first and second channel interactions over the date period; compare the date of a first one of the assigned first channel interactions with the corresponding date of the first party's calendar data, and when the calendar data indicates there is a conflict, shifting the first one of the assigned first channel interactions by one day and comparing the new date with the corresponding date of calendar data.

### CROSS-REFERENCE TO RELATED APPLICATIONS

This application is a continuation-in-part of pending U.S. Non-Provisional patent application Ser. No. 13/889,283, filed May 7, 2013 and entitled “SYSTEM AND METHOD FOR PLANNING A SCHEDULE FOR A WORKER BASED ON SCHEDULED EVENTS AND SUGGESTED ACTIVITIES” (which is included herewith in the attached Appendix), which claims priority from U.S. Provisional Application No. 61/800,939, filed on Mar. 15, 2013 and entitled “SYSTEM AND METHOD FOR PLANNING A SCHEDULE FOR A WORKER BASED ON SCHEDULED EVENTS AND SUGGESTED ACTIVITIES,” each of which are incorporated herein by reference in their entireties. U.S. Non-Provisional patent application Ser. No. 13/889,283 is also a continuation of U.S. Pat. No. 8,744,890, filed on Feb. 14, 2013 and entitled “SYSTEM AND METHOD FOR MANAGING SYSTEM-LEVEL WORKFLOW STRATEGY AND INDIVIDUAL WORKFLOW ACTIVITY,” which is also hereby incorporated by reference in its entirety.

### BACKGROUND

### 1. Field

Aspects of example embodiments of the present invention relate to a method of iterative scheduling of, for example, a workforce to achieve a target or goal and a system of the same.

### 2. Related Art

Generally, companies or corporations develop marketing and sales strategies prior to entering a new market or increase their market share in an existing market. Many companies or corporations employ, either directly or through a third party entity, salespeople to interact with (e.g., visit, call, e-mail, etc.) existing and prospective customers or clients. The marketing and sales strategies will often include the salespeople as one aspect, along with, for example, advertising or discount programs.

In many instances, the cost of employing or contracting salespeople is the most expensive component of a marketing and sales strategy. Accordingly, companies or corporations want to ensure the salespeople are being used effectively and efficiently to ensure the greatest return on investment. The effectiveness and efficiency of salespeople can refer to how frequently they communicate with particular customers or potential customers, how much time they spend traveling between appointments, what message or information they convey to the customer or potential customer, etc.

In some cases, one corporation may sell numerous different products to the same group of customers or potential customers. For example, in the pharmaceutical industry, many corporations sell different drugs to the same doctors, such as primary care physicians. In these cases, the salespeople may be tasked with marketing multiple, different products to a customer or potential customer during a single visit. This adds another layer of complexity to the planning and execution of the marketing strategy as the product or products a salesperson should discuss during a time-limited meeting with a customer or potential customer must also be considered.

The complexity is not limited to the corporate side. The salespeople also face the difficult task of balancing the various requirements promulgated by the marketing strategy in addition to driving to visits, calling, and e-mailing the customers or potential customers and staying abreast of relevant developments in the field in which they are selling products.

### SUMMARY

This summary is provided to introduce a selection of features and concepts of example embodiments of the present invention that are further described below in the detailed description. This summary is not intended to identify key or essential features of the claimed subject matter nor is it intended to be used in limiting the scope of the claimed subject matter. One or more of the described features according to one or more example embodiments may be combined with one or more other described features according to one or more example embodiments to provide a workable method or device.

A decision support engine for dynamically scheduling interactions between a first party and a second party is provided. The decision support engine is in communication with an external electronic device and includes: a processor and a memory coupled to the processor. The memory having stored therein instructions, that, when executed by the processor, cause the processor to: receive an inputted target file including a target number of first channel interactions between the first and second parties and a target number of second channel interactions between the first and second parties, the target number of first channel interactions and the target number of second channel interactions being integer values; receive an inputted date period; receive calendar data of the first party; distribute the first channel interactions over the date period by: dividing an integer value of the date period by the integer value of the target number of first channel interactions to provide a days per first channel interaction value result and assigning a first channel interaction on every date of the date period that is an integer multiple of the days per first channel interaction value result; distribute the second channel interactions over the date period by: dividing the integer value of the date period by the integer value of the target number of second channel interactions to provide a days per second channel interaction value result and assigning a second channel interaction on every date of the date period that is an integer multiple of the days per second channel interaction value result; compare the date of a first one of the assigned first channel interactions with the corresponding date of the first party's calendar data, and when the calendar data indicates there is a conflict, shifting the first one of the assigned first channel interactions by one day to a new date and comparing the new date of the assigned first one of the first channel interactions with the corresponding date of calendar data; estimate availability of the second party on the date of the first one of the assigned first channel interactions based on prior scheduled interactions with the first party determined from the calendar data, and when it is determined that the first and second party have not previously interacted on a day of week corresponding to the date of the first one of the assigned first channel interactions, shifting the first one of the assigned first channel interactions by one day to a new date and estimating availability of the second party on the new date of the first one of the assigned first channel interactions; and output the date or the new date of the first one of the assigned first channel interactions and a date of the first one of the assigned second channel interactions to the external electronic device.

The date period may include a calendar state date and a calendar end date.

The date period may include a calendar start date and a date range as an integer value.

The first channel may be in-person, and the second channel may be e-mail.

The calendar data of the first party may be received from the external electronic device via the Internet.

The decision support engine may include instructions, that, when executed by the processor, cause the processor to: receive location data of the first party; receive location data of the second party; and determine a linear distance between the first party and the second party based on the received location data of the first party and the received location data of the second party.

The location data of the first party may include latitude and longitude coordinates, and the location data of the second party may include latitude and longitude coordinates.

The decision support engine may include instructions, that, when executed by the processor, cause the processor to: determine whether the first one of one of the first channel interactions occurred; when it is determined that the first one of one of the first channel interactions did not occur: shift the first one of the first channel interactions by one day to a second new date and comparing the second new date of the first one of the first channel interactions with the corresponding date of calendar data; and output the second new date of the first one of one of the first channel interactions to the external electronic device.

The decision support engine may determine the first one of one of the first channel interactions did not occur based on an input from the external electronic device.

The decision support engine may determine the first one of one of the first channel interactions did not occur based on location data received from the external electronic device.

A decision support engine for dynamically scheduling interactions between a first party and a plurality of third parties is provided. The decision support engine includes: a processor and a memory coupled to the processor. The memory having stored therein instructions, that, when executed by the processor, cause the processor to:

receive a target file including a target number of interactions between the first party each of the third parties, the target number of interactions between the first party and each of the third parties being an integer value; receive a date range as an integer value and a start date corresponding to a calendar data; receive calendar data of the first party; receive location data of the first party; receive location data of each of the third parties; distribute the interactions over a date period, the date period being determined from the date range and the start date, by: dividing the integer value of the date range by the integer value of the target number of interactions for each of the third parties to provide a days per interaction value result for each of the third parties; assigning an interaction on every date of the date period that is an integer multiple of the days per interaction value result for each of the third parties; when a plurality of interactions are assigned on a first date: determining linear distances between the first party and each of the third parties having interactions on the first date; assigning the interaction with the nearest of the third parties to the location of the first party to a first time slot on the first date; determining linear distances between the location of the third party assigned to the first time slot and each of the remaining third parties having interactions on the first date; and assigning the interaction with the nearest of the third parties to the third party assigned to the first time slot to a second time slot on the first date; and output the assigned interactions during the date period to an electronic device from which the calendar data was received.

The calendar data and the location data of the first party may be received from the electronic device via the Internet.

The assigned interactions may be output to the electronic device via the Internet.

The location data of the first party may include latitude and longitude coordinates, and the location data of each of the third parties may include latitude and longitude coordinates.

### BRIEF DESCRIPTION OF THE DRAWINGS

FIG. 1 is a flowchart illustrating a method of iterative scheduling of a workforce to achieve a target or goal;

FIG. 2 is a diagram of a system for executing the method of FIG. 1;

FIG. 3 is an example schedule generated by the method of FIG. 1 and the system of FIG. 2;

FIG. 4 is a schematic diagram of a decision support engine (DSE) according to an exemplary embodiment;

FIG. 5 illustrates a method of dynamically scheduling interactions between a first party and a second party by using the DSE according to an embodiment of the present invention;

FIGS. 6A and 6B illustrate sub-methods of the method of FIG. 5;

FIG. 7 illustrates a method of dynamically scheduling interaction(s between a first party and a plurality of second party by using the DSE according to an embodiment of the present invention; and

FIG. 8 illustrates a sub-method of the method of FIG. 7.

### DETAILED DESCRIPTION

According to one example embodiment, an iterative scheduling system and a method of the same is provided that coordinates a team of salespeople to efficiently meet standards set by a sales or marketing strategy. For ease of description, this system is referred to herein as the “Decision Support Engine” or “DSE.”

Generally, a corporation develops a sales or marketing strategy that details, for example, the product or products that will be marketed, a number of salespeople (also referred to as “reps,” as in “representatives”), and the overall geographic area to be covered. Some marketing strategies may be more detailed and may include, for example, the geographic area assigned to each salesperson, customers or potential customers (jointly referred to herein as “customers” for convenience) assigned to each salesperson, the total number of times each salesperson should interact with each customer, and/or how each interaction should be conducted, such as by an in-person visit, telephone call, e-mail, etc. In some instances, a marketing strategy may inform a salesperson whom they should interact with, a total number of interactions over a time period, where the customers are located, etc. For example, a marketing strategy may instruct a salesperson to interact with a first customer a total of three times over a three week period but may leave the timing of those interactions up to the salesperson's discretion. This may be referred to as “pacing.”

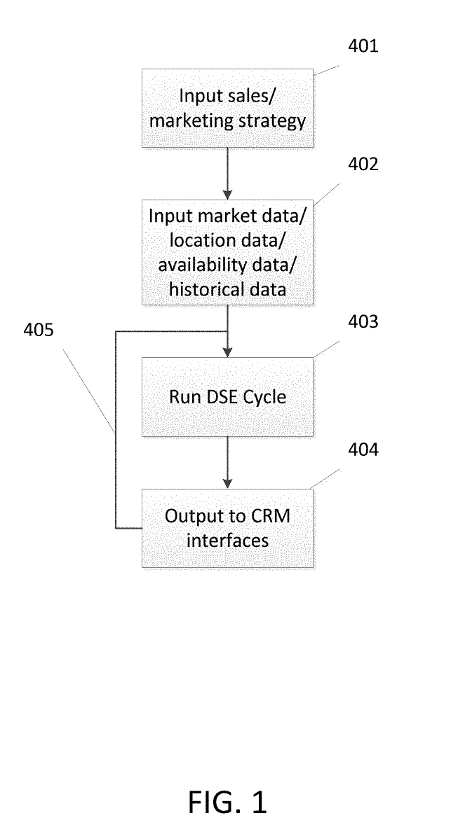

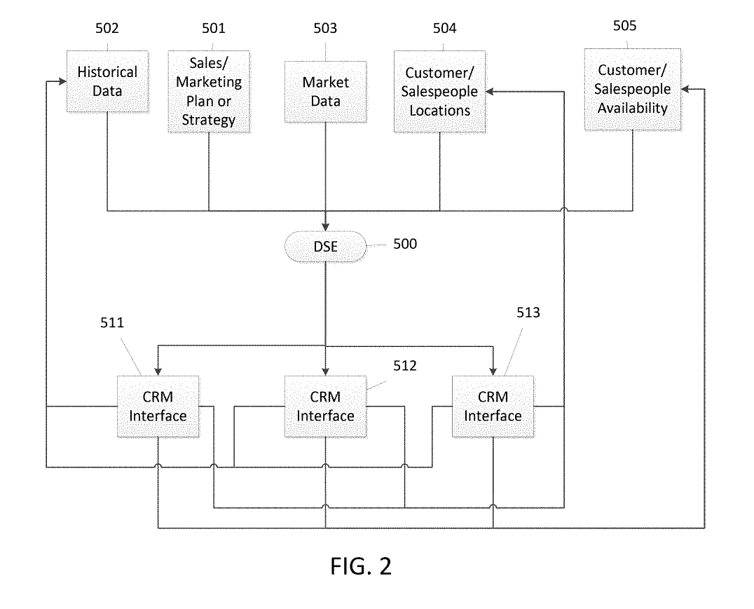

Referring to FIGS. 1 and 2, a marketing strategy 501 may be input into a decision support engine (DSE) 500 (401). The marking strategy may include a list of all available salespeople, a list of the customers to be engaged, the products to be marketed to the customers, and a number of times a particular customer should be contacted by a salesperson for a time period, such as a week, month, year, etc.

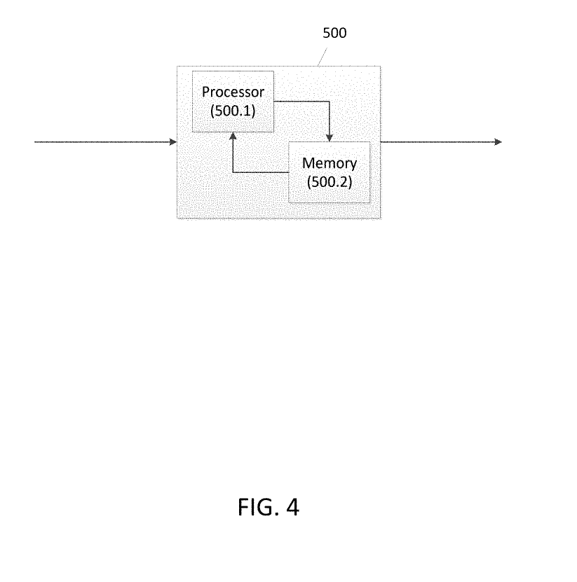

As shown in FIG. 4, the DSE 500 may include a processor 500.1 and a memory 500.2 coupled to the processor 500.1. The memory 500.2 may be volatile and/or non-volatile memory, such as a hard disk drive (HDD), a solid-state drive (SSD), dynamic random access memory (DRAM), etc. The memory 500.2 may store instructions therein that, when executed by the processor 500.1, cause the processor 500.1 to perform certain actions, to be further described below.

The DSE 500 may be, for example, a server computer connected to a wide area network (WAN), such as the Internet, and/or a local area network (LAN). The DSE 500 may communicate with other electronic devices, such as computers, laptop computers, tablets, smart phones, etc. via the WAN/LAN connection illustrated in FIG. 4 by the arrows into and out of the DSE 500.

In addition to the marketing strategy 501, historical data 502, market data 503, location data 504, and availability data 505 may also be input into the DSE 500 (402).

Once the marketing strategy 501 and other data 502-505 are input into the DSE 500, the DSE 500 may complete a computational cycle (403). In some embodiments, the DSE 500 may complete a computation cycle once a day, for example, overnight. In other embodiments, the DSE 500 may run in real-time as opposed to running in discontinuous cycles.

The DSE 500 outputs the results of the computational cycle (403) to a plurality of interface devices 511-513, such as tablet computers, smartphones, laptop computers, desktop computers, etc. (404). The interface devices 511-513 may be running customer relationship management (CRM) software; but the present invention is not limited thereto. The interface devices 511-513 may be connected to the DSE 500 via an Internet connection or the like. The interface devices 511-513 may be configured for bidirectional communication with the DSE 500. For example, as further described below, the interface devices 511-513 may record information, such as location information using a GPS module, input information, etc., that is transmitted back to the DSE 500 for consideration in later computational cycles (405).

During the computational run, the DSE determines a schedule for each salesperson of the marketing strategy. The schedule for each salesperson may detail what that salesperson should do for each working day for the remainder of the length of the marketing strategy to efficiently meet the requirements of the marketing strategy.

For example, the DSE may determine when (e.g., what day) a salesperson should contact, or intact with, a particular customer, what product or products should be discussed during the interaction, how the customer should be contacted, e.g., via telephone, e-mail, or in-person visit, and any message or information that should be conveyed to the customer during the interaction.

In its most basic iteration, when a marketing strategy has a salesperson interacting with customer A three times and is four weeks in duration (referred to herein as a “marketing period” or “time period”), the DSE will schedule the salesperson to interact with customer A six days into the marketing period, then again seven days after the first interaction (i.e., thirteen days into the marketing cycle), and then finally seven days after the second interaction (i.e., twenty days into the marketing cycle). This may be referred to as “pacing,” as in pacing the salespeople/customer interactions over the time period. However, this most basic example rarely happens in practice, as there are a plurality of salespeople, each salesperson is assigned multiple customers, the interaction schedule may be different for each of the customers, the customers may have limited availability, distances between customers may limit how many customers a salesperson can visit in a particular day, etc.

In some embodiments, the marketing strategy may further define different types of interactions between a salesperson and a customer. For example, building on the above example, the marketing strategy may have the salesperson interacting with customer A three times but may further define that two of the interactions are to be in-person visits while the third interaction is to be a send interaction (e.g., a phone call, e-mail, teleconference, etc.). In this case, the DSE will schedule the first and last interactions to be in-person visits and the second (or middle) interaction to be the send interaction (e.g., a phone call, e-mail, or teleconference interaction).

Up to this point, only examples including one salesperson and one customer have been described. However, the DSE is configured to consider a plurality of salespeople and a plurality of customers. When the marketing strategy includes a plurality of salespeople and a plurality of customers, the DSE can determine which salesperson will interact with each customer, the type of interaction (e.g., a visit or send), and when each interaction will occur. When the marketing strategy includes a plurality of different products, the DSE can also determine which product or products will be discussed at each interaction.

The DSE also considers that each salesperson has limited capacity for interactions in a given day. For example, a salesperson may only be able to reasonably conduct two to four visit interactions in a single day, considering the drive time and distance between the various customers' locations. Accordingly, even when a number of visit interactions may be best scheduled on a certain day, the DSE will move some interactions to different days to avoid overscheduling one day. For example, the DSE may consider the customers' locations and schedule a number of visit interactions on a single day based on the closeness of the customers.

Further, the DSE will also consider that each salesperson can only conduct a certain total number of interactions, including both visits and sends, in a single day. For example, even though send interactions do not require any travel time, each salesperson only has a limited capacity for send interactions in a single day. To this end, the DSE will also ensure that a single salesperson is not scheduled with too many (e.g., greater than five) interactions in a single day.

To most efficiently schedule the interactions, the DSE will, in some embodiments, consider the location of each of the customers in relation to the salespeople, the availability of each of the salespeople and the customers, historical data (called “affinity”) of what customers are often interacted with on the same day, and salesperson acceptance rate, to be further described below.

The DSE may consider the location of each of the salespeople and the customers when determining the interaction schedule. For example, each salesperson may be assigned a territory. The territory may be, for example, a “home” address (e.g., a street address and/or GPS coordinates) and a distance value the salesperson may travel from the home address. In other embodiments, the territory may be a route or may be an irregularly shaped area of a map that a salesperson is assigned to cover. When scheduling, the DSE may provider a higher score to a customer that is in and/or nearest to a particular salesperson's territory. For example, the DSE may associate a certain customer with a certain salesperson based on the customer's location and the salesperson's territory. When a customer is within a plurality of salespeople's territories, the DSE may more heavily weight to, or give a higher score, a customer/salesperson pair that are nearest to each other, thereby that salesperson is more likely to be assigned an interaction with that customer compared with other salespeople that are located further away (e.g., other salespeople that have territories that are further away from that customer).

The customers' and salespeople's locations may be regularly updated. For example, the interface device (e.g., the tablet computer or the like) with which the salespeople interface with the DSE may include a GPS module that tracks the salespeople's locations in real-time. The DSE may use this information to determine each salesperson's general route, home location, and locations of the customers. For example, if a salesperson is scheduled to have a visit interface with customer A at a certain time, the DSE may track the salesperson's location at the time of the visit interface with customer A to determine customer A's location. In some embodiments, the DSE may track such locations over a few days or weeks and only update its determined location of customer A after a salesperson has interfaced with customer A at a single location or area a number of times, ensuring that customer A's location is not misidentified.

The DSE may also consider the customer's and the salespeople's availability when scheduling. For example, the DSE may receive data from a customer's calendar software, such as Outlook, Google Calendar, or the like, and may receive similar data from the salespeople's calendar software. In some embodiments, the salespeople may iteratively update the data input to the DSE as they learn, or become aware of, each customer's availability. For example, when a certain customer is usually unavailable from 2 pm to 3 pm every day, a salesperson may indicate that the customer is unavailable every day from 2 pm to 3 pm. Then, the DSE will take this customer's unavailability into consideration when scheduling interactions with that customer. In some embodiments, the salesperson may use a calendar interface in the interface devices to input the customer's unavailability into the DSE.

Similarly, each salesperson may input their own availability into the DSE. For example, each salesperson may use a calendar interface to indicate when he or she is available for interactions with customers and when he or she is not available. The DSE will take each salesperson's availability into consideration when scheduling interactions with the customers. By considering both the customers' and the salespeople's availability schedules, the DSE will avoid scheduling an interaction involving a customer or a salesperson when the customer or salesperson is not available.

In some cases, salespeople may input interactions they have scheduled independently from the DSE. For example, during an interaction with a customer, that customer may ask the salesperson come back on a particular day in the future for a follow-up. The salesperson may then schedule an interaction on the day requested by the customer on the interface device. The DSE will then schedule around this manually scheduled interaction. Because this interaction is scheduled manually, the DSE will not move, modify, or reschedule this interaction, regardless of other factors that may change. That is, the DSE recognizes manually-scheduled interactions as having more importance and being more firm than its scheduled interactions and, accordingly, will not reschedule manually scheduled interactions.

Further, the DSE may consider historical data (also called affinity data) when scheduling interactions. As will be further described below, a salesperson may indicate to the DSE whether or not they interacted with a particular customer when scheduled by the DSE. For example, when a salesperson is scheduled to interact with a customer on a certain day, the salesperson may respond by indicating that the interaction did not or will not take place by using the interface device. The salesperson may further indicate the reason why the interaction did not or could not take place, for example, the customer was unavailable, the customer was too far from the salesperson on the scheduled day, etc. When a salesperson repeatedly indicates, for example, a customer is unavailable on a particular day or at a particular time, the DSE will update that customer's availability to indicate that the customer is not available at that day or time.

Other historical, or affinity, data that is tracked by the DSE includes which salesperson interacts with which customer on a regular basis. For example, one customer may be assigned to multiple salespeople. The DSE may determine a trend in which salesperson from among the salespeople assigned to a customer regularly interacts with that customer and may weigh the relationship between that salesperson and that customer more heavily than the relationship between the other assigned salespeople and that customer. However, after a certain amount of time has passed, the relationship between that salesperson and customer may fade. Accordingly, the DSE will allow this affinity between that salesperson and that customer to slowly fade by, for example, lessening the weight given to that relationship over time, as is more fully described below.

The DSE may also consider prior interactions between customers and salespeople when scheduling future interactions. For example, as the time period of a marketing strategy proceeds, the DSE will record when an interaction occurs between a particular customer and salesperson. For example, the salesperson can indicate via an input to the interface device when he or she has completed an interaction with a customer or when he or she will complete the interaction. The DSE will record this input as a confirmation that the interaction took place. The DSE will then decrement the number of remaining interactions for that particular customer as required by the marketing strategy. Further, the DSE will consider the prior interaction(s) when scheduling future interactions to avoid bothering or otherwise interacting with a particular customer too frequently.

For example, when a marketing strategy requires that one or more salespeople interact with customer A four times during a time period and a salesperson indicates that he or she has or will interact with customer A, the DSE will decrement the number of remaining interactions with customer A by one. Further, the DSE will consider when the interaction with customer A took place and schedule the remaining (e.g., the three remaining) interactions with customer A accordingly. For example, as described above, the DSE generally schedules the interactions with customer A at regular intervals over the time period. However, in some instances, a salesperson may interact with customer A at a time other than when the DSE has scheduled an interaction. In some instances, a salesperson may unexpectedly bump into customer A while meeting with customer B. To avoid inefficiency, the salesperson may take that opportunity to interact with customer A as if the interaction had been scheduled by the DSE. After the interaction, the salesperson may report the interaction to the DSE via the interface device, and the DSE will record that interaction and decrement the remaining interactions with customer A for the time period. Further, the DSE will then reconsider or reschedule the remaining interactions with customer A in view of the unscheduled interaction. For example, the DSE may then consider the remaining number of interactions set forth in the marketing plan and the remaining number of days in the time period and regularly schedule (or pace) the remaining interactions accordingly. As described above, the DSE may also take into consideration the customer's schedules, the salesperson's schedules, the respective locations of the customer and the salespeople, etc. Thus, a situation in which a salesperson has an unscheduled interaction with customer A and then soon thereafter (e.g., within two-four days) has a scheduled interaction with customer A is avoided by the DSE rescheduling the interactions with customer A based on the unscheduled interaction with customer A.

In some embodiments, the DSE may also consider prior interactions before a new time period starts. For example, when a new marketing strategy is input into the DSE, the DSE may consider interactions with the customers from a previous time period or from a time before the time period of the new marketing strategy. Similar to the consideration of unscheduled interactions, by considering interactions from before a time period starts, the DSE can avoid a customer being repeatedly contacted by a salesperson even though a new time period has begun.

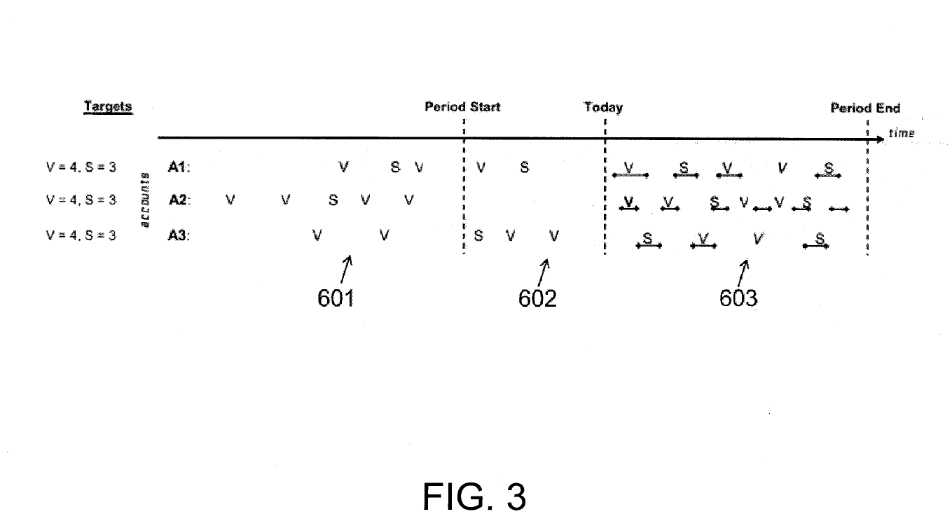

FIG. 3 shows an example schedule generated by the DSE. In FIG. 3, the “targets” column lists the number of interactions, broken up into visits (“V”) and sends (“S”) (e.g., phone calls, e-mails, teleconferences, etc.), the rows indicate three customers A1-A3, “Period Start” indicates the start of the time period of the marketing strategy, “Today” indicates the current day of the time period, and “Period End” indicates the last day of the time period.

As can be seen, in this example, the DSE has recorded and is considering interactions with customers A1-A3 from before the start of the time period as shown in the area indicated by 601. The period 601 before Period Start may be the end of an earlier marketing strategy time period, for example. Further, the DSE has recorded and is considering interactions that occurred after the Period Start but before Today as shown in the area indicated by 602 between the “Period Start” line and the “Today” line.

The interactions shown after the “Today” line and before the “Period End” line, in the area indicated by 603, are the scheduled interactions generated by the DSE. As can be seen, the total interactions, both visits and sends, between the “Period Start” line and the “Period End” line for customers A1 and A3 is the same as under the “Targets” column, indicating that customers A1 and A3 will be interacted with the prescribed number of times as set forth in the marketing plan. For customer A2, there were no interactions between the start of the time period and today. This could be due to the salesperson declining or being unable to interact with customer A2 on the originally scheduled days. In this case, the DSE provides the next best schedule to substantially meet the target. For example, the DSE has scheduled four visits and two sends, which substantially meets the target of four visits and three sends. Further, the DSE may prioritize visit interactions over send interactions as visits may be considered to be more valuable. For example, a visit may be more likely to result in a sale or increased sales to a customer than a send interaction. The DSE may send an indication to the salespeople that regularly meet with customer A2 indicating that they can no longer meet the target and may also send a notification to a supervisor or the like indicating the same.

As can also be seen in FIG. 3, the scheduled interactions include a horizontal bar under the type of interaction. This horizontal bar indicates alternative dates that are available for that scheduled interaction. In some embodiments, the DSE may provide alternative dates to salespeople to interact with customers that are suitable in view of the input information, such as customer availability, location, etc. This way, if a salesperson is unable or unwilling to interact with a customer, or if the customer is unwilling or unable to interact with a salesperson, on a particular day, an alternative date for the interaction is presented and available to the salesperson. When the salesperson accepts the alternative date, the DSE may reschedule the remaining interactions or may not reschedule the remaining interactions, depending on how many days removed from the originally scheduled interaction the alternative date is.

The DSE may also include a set of rules-based triggers. For example, when a certain condition is met, the DSE may trigger an interaction with a certain customer, regardless of the pending scheduled interactions. As one example, a trigger may be an increase in a product A's market share above a threshold value. The information about product A's market share may be input into the DSE as part of the market data 503. As another example, a trigger may be a particular customer opening an e-mail. For example, if a salesperson sends an e-mail to customer A in response to the DSE scheduling a send interaction and then customer A opens that e-mail, the DSE, by using read receipts or the like, may advance the next visit interaction with customer A to the soonest acceptable time, as further described below.

When the trigger occurs, such as the increase in product A's market share above the threshold value, the DSE may schedule an interaction with a customer or customers that use or sell product A for that same day or the next day. In some cases, the DSE may schedule a send interaction in response to the triggering event to avoid disrupting the salespeople's driving routes with a visit interaction. However, the rules may be configurable to allow for the immediate or substantially immediate (e.g., within one to two days) scheduling of a visit interaction.

In some embodiments, the triggers may work with the existing schedule determined by the DSE. For example, as discussed above, the DSE determines acceptable alternative dates for the scheduled interactions. In response to a triggering event, the DSE may advance previously-scheduled interactions with the corresponding customer or customers to the maximum extent permitted by the previously-determined alternative dates (e.g., the DSE may move a previously-scheduled interaction up to the earliest previously-determined alternative date). However, the DSE is not limited thereto. In some instances, depending on how the rules of the trigger are set, the DSE may schedule an interaction for the next day, regardless of any previously-scheduled interactions.

The DSE may use a scoring method to schedule the interactions. For example, the DSE may first pre-schedule the interactions based on the number of interactions per customer and available salespeople in the marketing strategy. Here, the DSE may schedule interactions at regular intervals to meet the interaction targets in the marketing plan. The pre-scheduled interactions may be given scores based on pacing of, for example, one to three, with a score of three being given to the day the DSE pre-scheduled the interaction, a score of two being given to the two days on either side of the day the DSE pre-scheduled the interaction, etc. The DSE may also score the pre-scheduled interactions based on location. For example, an interaction with a customer that is within a first distance of the corresponding salesperson may be given an additional point, while an interaction with a customer that is outside of a second distance of the corresponding salesperson may have a point subtracted. The DSE may also consider salesperson and customer availability. For example, when both a salesperson and a customer are available on a same day, that interaction may be given two additional points. On a day when a customer is not available, that interaction may have three points (or some larger number) subtracted to ensure that no interaction is scheduled on that day. When there is no information about a customer's availability on a certain day, that day may score modification (e.g., neither a positive nor negative score) for availability.

Then, the DSE will consider scores of certain salesperson/customer pairs on different days and will schedule (or re-schedule or iteratively schedule) the interactions accordingly. For example, the DSE may pre-schedule an interaction between salesperson A and customer A on day three but may later determine that the salesperson A/customer A interaction has a higher score on day two due to, for example, customer A being available on day two. Accordingly, the DSE may move the salesperson A/customer

A interaction from day three to day two due to day two having a higher score due to customer availability.

As another example, the DSE may determine that salesperson B/customer A on day three has a higher score than salesperson A/customer A on day three. This could be because salesperson B is expected to be nearer to customer A on day three than salesperson A is due to, for example, salesperson B having visit interactions with other customers near customer A on day three. Accordingly, the DSE may change the salesperson A/customer A interaction on day three to be salesperson B/customer A interaction on day three.

Further, the DSE may assign a numerical value to a salesperson/customer pair based on their affinity, or history of interactions. It is assumed that a salesperson that regularly meets with a customer will build and maintain a relationship with that customer, increasing the value of that relationship. Accordingly, the DSE will give a higher score (or additional points) to that salesperson/customer pair than it would to other salespeople and that customer to increase the regularity with which the preferred salesperson interacts with that customer. For example, the DSE may give a salesperson/customer pair a score of three (e.g., three additional points) when they have a high affinity, that is, a relatively high number of recent interactions, and a score of zero (e.g., no points modification) when they do not have a history of recent interactions. When the salesperson/customer pair has a high number of interactions but they are less recent (e.g., more than a month ago), the DSE may give that salesperson/customer pair a score of two or less (e.g., may only add two or fewer points), and the score may decrease as the time since the last interaction increases. This may be referred to as affinity decay and may be modeled as a linear or exponential function.

In addition to scheduling interactions between salespeople and customers, the DSE may further provide instruction to the salespeople as to which products they should discuss during the interaction and in which order. For example, some products may have higher margins for a company than other products, or a company may pay more for salespeople to discuss one product verses another product. Accordingly, the DSE may further indicate to the salespeople which product or products should be discussed during each interaction and in which order. The DSE may take into consideration the marketing strategy, what products were previously discussed with the customer, any market changes or other information relevant to the products, etc. Thus, when salesperson A interacts with customer A and discusses product A, salesperson B can later interact with customer A and discuss product B as instructed by the DSE to avoid repetition and losing customer A's interest, even though salespeople A and B may not directly interact with each other. That is, the DSE can manage interactions with customers among a plurality of salespeople without the salespeople directly interacting with each other.

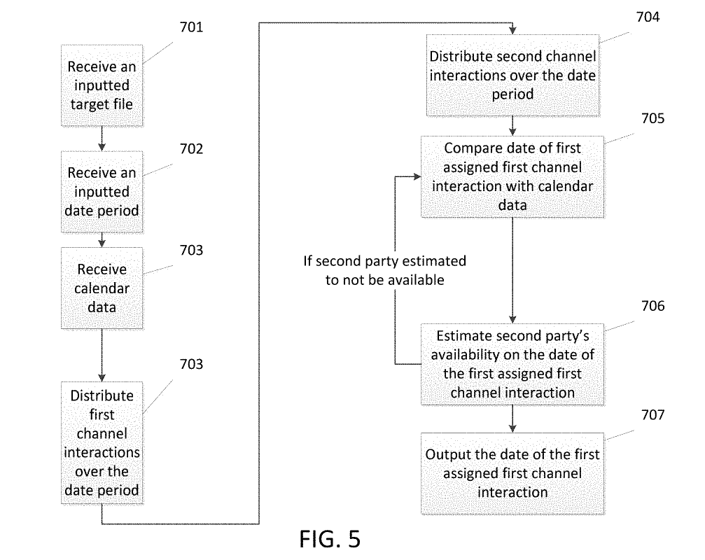

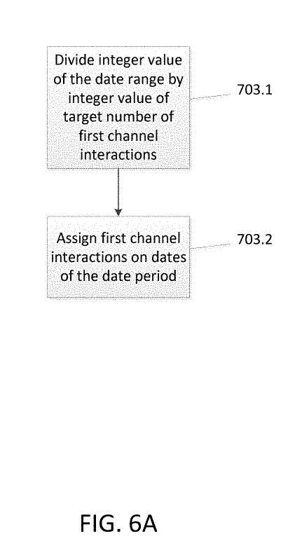

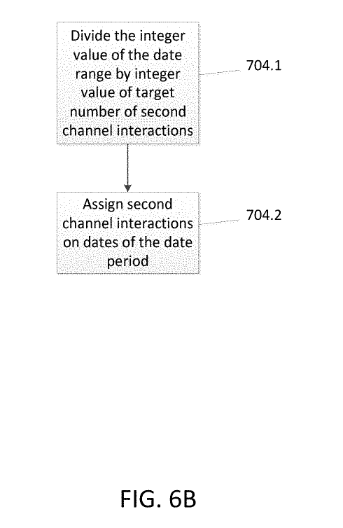

FIGS. 5-6B illustrate a method of dynamically scheduling interactions between a first party and a second party by using the DSE 500 according to an embodiment of the present invention. Referring to FIG. 5, the DSE 500 receives an inputted target file (701). The target file may be received via a network interface, such as via LAN or WAN, or may be uploaded from a local memory device, such as a flash drive. Similarly, all other inputted data may be received via the network interface or from a local memory device, and repeated descriptions thereof will be omitted for brevity.

The target file includes a target number of first channel interactions between the first and second parties and a target number of second channel interactions between the first and second parties. The number of first and second channel interactions may be indicated by integer values, such as one, five, ten, etc. The first channel interactions may be in-person interactions, and the second channel interactions may be e-mail interactions. The present invention, however, is not limited thereto, and in other embodiments, the first and/or second channel interactions may include phone calls, conference attendance, etc.

The DSE also receives an inputted date period (702). The date period may be a period of calendar dates, such as June 1-June 11. In this case, the DSE 500 can calculate a date range by determining (e.g., counting) the number of days between the start date and the end date. The date range is an integer value, such as ten days, thirty days, sixty days, ninety days, one hundred eighty days, etc. As one example, the date range may be 10 and a start date may be June 1. In this case, the date period would be from June 1 to June 11. However, the present invention is not limited thereto, and in other embodiments, the DSE 500 may receive the date range and a start date as a calendar date. In such an embodiment, the DSE 500 may then calculate the date period based on the start date and the date range.

The DSE 500 also receives calendar data of the first party (703). The calendar data may be, for example, Google® calendar data, Outlook® calendar data, or any data that indicates the first party's availability. In some embodiments, the first party may input his or her availability directly into the DSE 500 without relying on an intermediate service. The calendar data may be inputted into the DST 500 from an external electronic device, such as a tablet PC, a laptop, a smartphone, etc. When the data is received from a third-party service, such as Google® or Outlook®, the calendar data is received from another server via, for example, the Internet.

While the acts (701-703) are shown as being sequential in FIG. 5, these acts can be performed in any order and may be performed concurrently or simultaneously.

After the target file, the date period, and the calendar data are received by the DSE 500 (701-703), the DSE 500 distributes the first channel interactions over the date period (703). Referring to FIG. 6A, the distributing the first channel interactions over the date period (703) includes dividing the integer value of the date range by the integer value of the target number of first channel interactions as included in the target file (703.1), as shown in Equation 1.

$$Equation 1$$

$$Days Per First Channel Interaction = \frac{integer value of date range}{target number of first channel interactions}$$

The days per first channel interaction indicates how frequently one of the first channel interactions should be scheduled such that the target number of first channel interactions is achieved during the date period.

The DSE 500 then assigns a first channel interaction on every date of the date period that is an integer multiple of the days per first channel interaction (703.2). For example, if the date range is 10 and the target number of first channel interactions is 5, the days per first channel interaction is 2 (10/5). Using this result, the DSE 500 assigns a first channel interaction on each date of the date period that is a multiple of 2. For example, assuming the start date of the date period is June 1 and the date range is 10, the date period would be from June 1-June 11 and a first channel interaction would be assigned on the second (June 3), fourth (June 5), sixth (June 7), eighth (June 9) and tenth (June 11) day of the date period.

At (704), the DSE 500 distributes the second channel interactions over the date period. This act is similar to the distributing of the first channel interactions over the date period (703). For example, as shown in FIG. 6B, first, the integer value of the date range is divided by the integer value of the target number of second channel interactions as included in the target file (704.1), as shown in Equation 2.

$$Equation 2$$

$$Days Per Second Channel Interaction = \frac{integer value of date range}{target number of second channel interactions}$$

The days per second channel interaction indicates how frequently one of the second channel interactions should be scheduled such that the target number of second channel interactions is achieved during the date period.

The DSE 500 then assigns a second channel interaction on every date of the date period that is an integer multiple of the days per second channel interaction (704.2). For example, if the date range is 10 and the target number of first channel interactions is 2, the days per first channel interaction is 5 (10/2). Using this result, the DSE 500 assigns a second channel interaction on each date of the date period that is a multiple of 5. Using the example from above in which the start date of the date period is June 1 and the date range is 10, a second channel interaction would be assigned on the fifth (June 6) and tenth (June 11) day of the date period.

For both the distributing of the first channel interactions over the date period (703) and the distributing of the second channel interactions over the date period (704), a result of Equation 1 and/or 2 may result in a fraction (e.g., a number with a decimal remainder). For example, if the date range is 10 and the target number of first channel interactions is 3, the days per first channel interaction would be 3.33333. In this case, the DSE 500 may round the result to the nearest integer, in this example, 3, or may truncate the result at the decimal point. To avoid scheduling fewer than the target number of interactions, however, in some embodiments, the DSE 500 may round down so as to err on the side of scheduling too many interactions relative to the target rather than too few interactions.

The DSE 500 then compares the date of a first one of the assigned first channel interactions with the corresponding date of the first party's calendar data (705). For example, the DSE 500 may determine whether the first party's calendar data on the date of the first one of the assigned first channel interactions indicates that the first party is available on that day. The DSE 500 may make this determination by determining whether a certain amount of time (e.g., one hour, a half hour, etc.) is open in the first party's calendar data on the date.

When the DSE 500 determines a conflict exists on the date, for example, when the first party's calendar data does not have a certain amount of time open for the assigned first channel interaction, the DSE 500 shifts the first one of the assigned first channel interactions by one day of the date period to a new date. For example, the DSE 500 may shift the date ahead by one day. The DSE 500 then compares the new date with the first party's calendar data to determine whether the first party is available on the new date. If the first party is not available on the new date, that is, if the first party has a conflict on the new date, the DSE 500 may shift the date to be one day before the date of the first one of the assigned first channel interactions, and then, the above process is repeated until a suitable date for the first one of the first channel interactions is determined.

The DSE 500 then estimates the second party's availability on the date of the first one of the assigned first channel interactions (706) determined above. The DSE 500 estimates the second party's availability by reviewing the first party's calendar data and/or any other calendar data the DSE 500 may have access to. For example, the DSE 500 may consider a day of the week of the first one of the assigned first channel interactions, such as Monday, Tuesday, etc. The DSE 500 may then review the first party's calendar data to determine whether the first party and the second party have ever had a first channel interaction on the same day of the week as the first one of the assigned first channel interactions. When the first and second parties have had a first channel interaction on the day of the week of the first one of the assigned first channel interactions, the DSE 500 determines that the second party is available on the date of the first one of the assigned first channel interactions. In many instances, second parties, such as health care providers, have relatively set schedules, meaning that if they were available for an interaction on a certain day of the week once, they are likely available on that same day in another week.

Further, in some embodiments, the DSE 500 may similarly consider a time of day for the assigned first channel interaction. For example, the DSE 500 may further determine what time of day the first and second parties previously interacted and may schedule the assigned first one of the first channel interactions for that same or a similar time period.

When it is determined that the first and second parties have not interacted on the day of week as the first one of the assigned first channel interactions, then the DSE 500 will shift the date of the first one of the assigned first channel interactions by one day then estimates the second party's availability on the new day of the week. This process is repeated until a suitable day of the week is found.

If the DSE 500 shifts the date of the first one of the assigned first channel interactions in the act of estimating the second party's availability, the DSE 500 may then re-consider the first party's availability on the new date by re-running act (705). If the DSE 500 determines that the first party is not available on this new date, then the DSE 500 may shift the date again and then re-run (706). This process will repeat until a date is found on which both the first party is determined to be available based on the calendar data and the second party is estimated to be available based on the calendar data.

The DSE 500 then outputs the date of the first one of the assigned first channel interactions to the external electronic device (707). This output may be a direct output, for example, directly to a calendar program on the external electronic device, or may be an indirect output, in which the DSE 500 outputs the data to a third-party calendar program, such as Google® calendar or Outlook®, and the third-party program then updates the external electronic device.

In some embodiments, the DSE 500 may also receive location data of the first party and location data of the second party. The location data may be received as latitude and longitude coordinates (e.g., GPS coordinates) or as street addresses, etc. The DSE 500 may then determine a linear distance between the first and second parties based on the location data. The DSE 500 may calculate this information by using the latitude/longitude coordinates or by using a third-party service, such as Google® maps or the like.

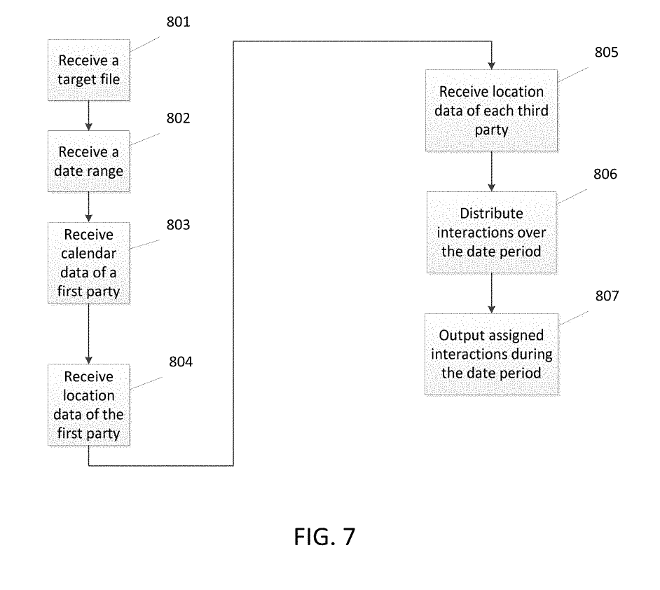

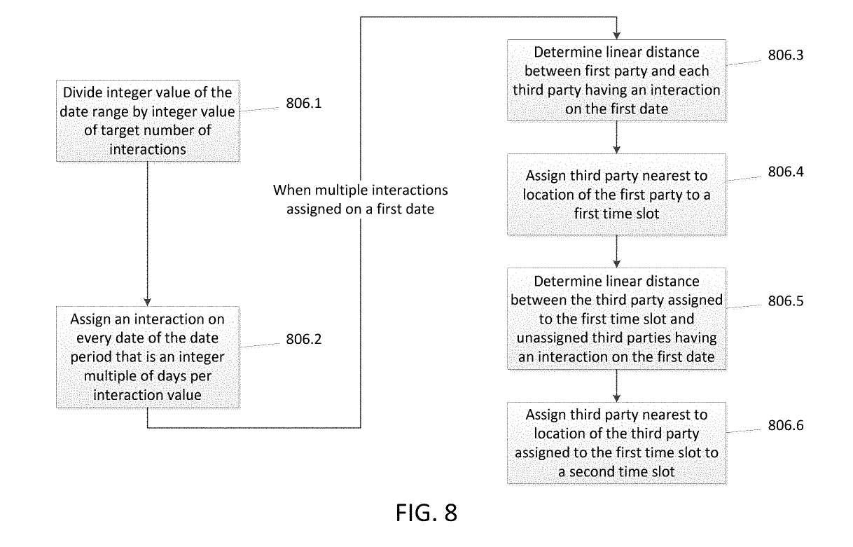

As will be discussed further below with respect to the embodiment shown in FIGS. 7 and 8, the DSE 500 may then order first channel interactions between different second parties based on the distance information determined from the location data.

Further, in some embodiments, the DSE 500 may determine whether a scheduled interaction occurred. The DSE 500 may determine this by monitoring a location of the external electronic device and, when the external electronic device does not go to a location near the known location of the second party on a date a first channel interaction is scheduled with the second party, determine the scheduled interaction did not occur. In other embodiments, a user of the external electronic device may upload a response to a question regarding whether a scheduled first channel interaction occurred.

When the DSE 500 determines a scheduled first channel interaction did not occur, the DSE 500 may shift the missed scheduled first channel interaction by one day and then run this new date through acts (705/706) of the above-described method. When a new date for the first channel interaction is found on which both the first party is available and the second party is estimated to be available, the DSE 500 outputs this second new date of the scheduled interaction to the external electronic device as discussed above.

FIGS. 7 and 8 illustrate a method of dynamically scheduling interactions between a first party and a plurality of second party by using the DSE according to an embodiment of the present invention.

Referring to FIG. 7, the DSE 500 may receive a target file (801), a date range (802), calendar data of the first party (803), and location data of the first party and of each of the third parties (804/805). These files and/or data may be received via a LAN or WAN, such as the Internet, or a local storage device, such as a flash drive.

The target file may include a target number of interactions between the first party and each of the third parties. The target number may be represented as an integer value, such as one, five, ten, etc.

The date range may be an integer value and may be received along with a start date as a calendar date. For example, the date range may be 10, and the start date may be June 1. In this example, a corresponding date period would be June 1-June 11. As discussed above, the DSE 500 is not limited thereto, and a start date and an end date may be received and the date range calculated from those dates.

The location data may be in the form of latitude/longitude coordinates or street addresses, etc.

Referring to FIGS. 7 and 8, after the above-described files and/or data is received, the DSE 500 distributes the interactions over the date period (806). The DSE 500 may use steps similar to those described above with respect to act (703). For example, the DSE 500 may divide the integer value of the date range by the integer value of the target number of interactions for each of the third parties to determine a days per interaction value for each of the third parties (806.1). The DSE 500 then assigns an interaction on every date of the date range that is an integer multiple of the days per interaction value result for each of the third parties (806.2).

In one example, if a date range is 10, a target number of interactions of a first one of the third parties is 2, a target number of interactions of a second one of the third parties is 3, and a target number of interactions of a third one of the third parties is 5, the DSE 500 may determine that a days per interaction value for the first third party is 5, a days per interaction value for the second third party is 3 after being rounded to the nearest integer, and days per interaction value for the first third party is 2. If the start date is June 1, the DSE 500 would schedule interactions as follows.

TABLE 1

| | June 1 | June 2 | June 3 | June 4 | June 5 | June 6 | June 7 | June 8 | June 9 | June 10 | June 11 |
|---|---|---|---|---|---|---|---|---|---|---|---|
| 1st | | | | | X | | | | | | X |
| Third | | | | | | | | | | | |
| Party | | | | | | | | | | | |
| 2nd | | | X | | | X | | | X | | |
| Third | | | | | | | | | | | |
| Party | | | | | | | | | | | |
| 3rd | | X | | X | | X | | X | | X | |
| Third | | | | | | | | | | | |
| Party | | | | | | | | | | | |

As can be seen in Table 1, in some instances, a plurality of interactions may be scheduled on a same date (referred to as the “first date” herein for ease of description). For example, in the above example, interactions with both the second and third third parties are scheduled on June 6.

When multiple interactions are scheduled on the same date (i.e., the first date), the DSE 500 then determines linear distances between the first party and each of the third parties having interactions on the first date (806.3). In the above example, the DSE 500 would determine linear distances between the first party and each of the second and third third parties due to the overlapping interactions scheduled on June 6.

Based on the results of (806.3), the DSE 500 then assigns the interaction with the third party that is nearest to the first party based on the determined linear distances. For example, the DSE 500 assigns the interaction with the third party nearest to the first party based on the determined linear distances to a first time slot on the first date (806.4).

Using the above example, the DSE 500 would determine the linear distance between the first party and the second third party and between the first party and the third third party. Assuming, as an example, the linear distance between the first party and the second third party was determined to be 4 miles and the linear distance between the first party and the third third party was determined to be 3 miles, the DSE 500 would assign the interaction with the third third party to a first time slot on June 6.

The DSE 500 then determines linear distances between the location of the third party assigned to the first time slot and each of the remaining unassigned third parties (806.5). Based on the results of (806.5), the DSE 500 then assigns the interaction with the third party that is nearest to the third party assigned to the first time slot to a second time slot on the first date (806.6). The acts (806.5/806.6) are repeated until all unassigned third parties on the first day have an assigned time slot.

The DSE 500 then outputs the assigned interactions to an electronic device from which the calendar data was received (807). For example, the DSE 500 may output the assigned interactions to a third-party service when that is from where the calendar data is received or may output the assigned interactions directly to an external device, such as a tablet, laptop, etc. The output of the calendar data may occur via the Internet.

As would be understood by one skilled in the relevant art, the features of the embodiments of FIGS. 5-8 may be variously combined and/or substituted.

Example embodiments of the present invention have been described herein with reference to the accompanying drawings. The present invention, however, may be embodied in various different forms and should not be construed as being limited to only the embodiments illustrated herein. Rather, these embodiments are provided as examples so that this disclosure will be thorough and complete and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

It will be understood that, although the terms “first,” “second,” “third,” etc., may be used herein to describe various acts, elements, components, and/or layers, these acts, elements, components, and/or layers should not be limited by these terms. These terms are used to distinguish one act, element, component, or layer from another act, element, component, or layer. Thus, a first act, element, component, or layer described below could be termed a second act, element, component, or layer without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components but do not preclude the presence or addition of one or more other acts, features, integers, steps, operations, elements, components, and/or groups thereof. That is, the acts, processes, methods, and algorithms described herein are not limited to the operations indicated and may include additional acts or operations or may omit some acts or operations, and the order of the acts or operations may vary according to some embodiments. As used herein, the term “and/or” includes any and all combinations of one or more of the associated listed items.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “example” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A processor, such as a central processing unit (CPU), graphics processing unit (GPU), field-programmable gate array (FPGA), and/or any other relevant devices or components according to embodiments of the present invention described herein may be implemented utilizing any suitable hardware (e.g., an application-specific integrated circuit), firmware, software, and/or a suitable combination of software, firmware, and hardware. For example, the various components of the processor, CPU, GPU, and/or the FPGA may be formed on (or realized in) one integrated circuit (IC) chip or on separate IC chips. Further, the various components of the processor, CPU, GPU, and/or the FPGA may be implemented on a flexible printed circuit film, a tape carrier package (TCP), a printed circuit board (PCB), or formed on the same substrate as the processor, CPU, GPU, and/or the FPGA. Further, the described actions, operations, steps, acts, etc. may be processes or threads, running on one or more processors (e.g., one or more CPUs, GPUs, FPGAs, etc.), in one or more computing devices, executing computer program instructions and interacting with other system components to perform the various functionalities described herein. The computer program instructions may be stored in a memory, which may be implemented in a computing device using a standard memory device, such as, for example, a random access memory (RAM). The computer program instructions may also be stored in other non-transitory computer readable media such as, for example, a CD-ROM, flash drive, hard drive (HDD or SSD), or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present invention.

Although the present invention has been described with reference to the example embodiments, those skilled in the art will recognize that various changes and modifications to the described embodiments may be performed, all without departing from the spirit and scope of the present invention. Furthermore, those skilled in the various arts will recognize that the present invention described herein will suggest solutions to other tasks and adaptations for other applications. It is the applicant's intention to cover by the claims herein, all such uses of the present invention, and those changes and modifications which could be made to the example embodiments of the present invention herein chosen for the purpose of disclosure, all without departing from the spirit and scope of the present invention. Thus, the example embodiments of the present invention should be considered in all respects as illustrative and not restrictive, with the spirit and scope of the present invention being indicated by the appended claims and their equivalents.

What is claimed is:

1. A decision support engine for dynamically scheduling interactions between a first party and a second party, the decision support engine being in communication with an external electronic device, the decision support engine comprising:
a processor; and
a memory coupled to the processor, the memory having stored therein instructions, that, when executed by the processor, cause the processor to:
receive an inputted target file comprising a target number of first channel interactions between the first and second parties and a target number of second channel interactions between the first and second parties, the target number of first channel interactions and the target number of second channel interactions being integer values;
receive an inputted date period;
receive calendar data of the first party;
distribute the first channel interactions over the date period by:
dividing an integer value of the date period by the integer value of the target number of first channel interactions to provide a days per first channel interaction value result; and
assigning a first channel interaction on every date of the date period that is an integer multiple of the days per first channel interaction value result;
distribute the second channel interactions over the date period by:
dividing the integer value of the date period by the integer value of the target number of second channel interactions to provide a days per second channel interaction value result; and
assigning a second channel interaction on every date of the date period that is an integer multiple of the days per second channel interaction value result;
compare the date of a first one of the assigned first channel interactions with the corresponding date of the first party's calendar data, and when the calendar data indicates there is a conflict, shifting the first one of the assigned first channel interactions by one day to a new date and comparing the new date of the assigned first one of the first channel interactions with the corresponding date of calendar data;
estimate availability of the second party on the date of the first one of the assigned first channel interactions based on prior scheduled interactions with the first party determined from the calendar data, and when it is determined that the first and second party have not previously interacted on a day of week corresponding to the date of the first one of the assigned first channel interactions, shifting the first one of the assigned first channel interactions by one day to a new date and estimating availability of the second party on the new date of the first one of the assigned first channel interactions; and
output the date or the new date of the first one of the assigned first channel interactions and a date of the first one of the assigned second channel interactions to the external electronic device.

2. The decision support engine of claim 1, wherein the date period comprises a calendar state date and a calendar end date.

3. The decision support engine of claim 1, wherein the date period comprises a calendar start date and a date range as an integer value.

4. The decision support engine of claim 1, wherein the first channel is in-person, and the second channel is e-mail.

5. The decision support engine of claim 1, wherein the calendar data of the first party is received from the external electronic device via the Internet.

6. The decision support engine of claim 1, comprising further instructions, that, when executed by the processor, cause the processor to:
receive location data of the first party;
receive location data of the second party; and
determine a linear distance between the first party and the second party based on the received location data of the first party and the received location data of the second party.

7. The decision support engine of claim 6, wherein the location data of the first party comprises latitude and longitude coordinates, and the location data of the second party comprises latitude and longitude coordinates.

8. The decision support engine of claim 1, comprising further instructions, that, when executed by the processor, cause the processor to:
determine whether the first one of one of the first channel interactions occurred;
when it is determined that the first one of one of the first channel interactions did not occur:
shift the first one of the first channel interactions by one day to a second new date and comparing the second new date of the first one of the first channel interactions with the corresponding date of calendar data; and
output the second new date of the first one of one of the first channel interactions to the external electronic device.

9. The decision support engine of claim 8, wherein the decision support engine determines the first one of one of the first channel interactions did not occur based on an input from the external electronic device.

10. The decision support engine of claim 8, wherein the decision support engine determines the first one of one of the first channel interactions did not occur based on location data received from the external electronic device.

11. A decision support engine for dynamically scheduling interactions between a first party and a plurality of third parties, the decision support engine comprising:
a processor; and
a memory coupled to the processor, the memory having stored therein instructions, that, when executed by the processor, cause the processor to:
receive a target file comprising a target number of interactions between the first party each of the third parties, the target number of interactions between the first party and each of the third parties being an integer value;
receive a date range as an integer value and a start date corresponding to a calendar data;
receive calendar data of the first party;
receive location data of the first party;
receive location data of each of the third parties;
distribute the interactions over a date period, the date period being determined from the date range and the start date, by:
dividing the integer value of the date range by the integer value of the target number of interactions for each of the third parties to provide a days per interaction value result for each of the third parties;
assigning an interaction on every date of the date period that is an integer multiple of the days per interaction value result for each of the third parties;
when a plurality of interactions are assigned on a first date:
determining linear distances between the first party and each of the third parties having interactions on the first date;
assigning the interaction with the nearest of the third parties to the location of the first party to a first time slot on the first date;
determining linear distances between the location of the third party assigned to the first time slot and each of the remaining third parties having interactions on the first date; and
assigning the interaction with the nearest of the third parties to the third party assigned to the first time slot to a second time slot on the first date; and
output the assigned interactions during the date period to an electronic device from which the calendar data was received.

12. The decision support engine of claim 11, wherein the calendar data and the location data of the first party are received from the electronic device via the Internet.

13. The decision support engine of claim 12, wherein the assigned interactions are output to the electronic device via the Internet.

14. The decision support engine of claim 11, wherein the location data of the first party comprises latitude and longitude coordinates, and the location data of each of the third parties comprises latitude and longitude coordinates.
